(19) United States
(12) Patent Application Publication
(10) Pub. No.: US 2026/0032707 A1
(43) Pub. Date: Jan. 29, 2026

(54) INDICATION FOR CYCLIC PREFIX EXTENSION

(71) Applicant: QUALCOMM Incorporated, San Diego, CA (US)

(72) Inventors: Shaozhen GUO, Beijing (CN); Xiaoxia ZHANG, San Diego, CA (US); Changlong XU, Beijing (CN); Jing SUN, San Diego, CA (US); Chih-Hao LIU, San Diego, CA (US); Giovanni CHISCI, San Diego, CA (US); Luanxia YANG, Beijing (CN); Siyi CHEN, Beijing (CN); Hao XU, Beijing (CN)

(21) Appl. No.: 18/996,762

(22) PCT Filed: Oct. 4, 2022
(86) PCT No.: PCT/CN2022/123693

§ 371 Date: Jan. 17, 2025

(51) Int. Cl. H04W 72/40; H04L 27/26

(52) U.S. Cl. CPC H04W 72/40; H04L 27/2607

(57) ABSTRACT

Various aspects of the present disclosure generally relate to wireless communication. In some aspects, a first user equipment (UE) may receive first sidelink control information (SCI) indicating a first reserved resource for a second UE. The UE may receive second SCI indicating a second reserved resource for a third UE. The UE may generate an indication of inconsistent cyclic prefix extensions (CPEs) based at least in part on a first CPE of the first reserved resource and a second CPE of the second reserved resource. The UE may transmit the indication to one or more of the second UE or the third UE. Numerous other aspects are described.

### FIELD OF THE DISCLOSURE

Aspects of the present disclosure generally relate to wireless communication and to techniques and apparatuses for indicating cyclic prefix extensions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include receiving first sidelink control information (SCI) indicating a first reserved resource for a second UE. The method may include receiving second SCI indicating a second reserved resource for a third UE. The method may include generating an indication of inconsistent cyclic prefix extensions (CPEs) based at least in part on a first CPE of the first reserved resource and a second CPE of the second reserved resource. The method may include transmitting the indication to one or more of the second UE or the third UE.

Some aspects described herein relate to a method of wireless communication performed by a second UE. The method may include transmitting, to a first UE, SCI indicating a reserved resource that is associated with a CPE. The method may include receiving an indication of inconsistent CPEs. The method may include adjusting a length of the CPE or using a preferred resource based at least in part on the indication.

Some aspects described herein relate to an apparatus of a first UE for wireless communication. The apparatus may include a memory and one or more processors coupled to the memory. The one or more processors may be configured to receive first SCI indicating a first reserved resource for a second UE. The one or more processors may be configured to receive second SCI indicating a second reserved resource for a third UE. The one or more processors may be configured to generate an indication of inconsistent CPEs based at least in part on a first CPE of the first reserved resource and a second CPE of the second reserved resource. The one or more processors may be configured to transmit the indication to one or more of the second UE or the third UE.

Some aspects described herein relate to an apparatus for a second UE for wireless communication. The apparatus may include a memory and one or more processors coupled to the memory. The one or more processors may be configured to transmit, to a first UE, SCI indicating a reserved resource that is associated with a CPE. The one or more processors may be configured to receive an indication of inconsistent CPEs. The one or more processors may be configured to adjust a length of the CPE or use a preferred resource based at least in part on the indication.

Some aspects described herein relate to a non-transitory computer-readable medium that stores a set of instructions for wireless communication by a first UE. The set of instructions, when executed by one or more processors of the first UE, may cause the first UE to receive first SCI indicating a first reserved resource for a second UE. The set of instructions, when executed by one or more processors of the first UE, may cause the UE to receive second SCI indicating a second reserved resource for a third UE. The set of instructions, when executed by one or more processors of the UE, may cause the first UE to generate an indication of inconsistent CPEs based at least in part on a first CPE of the first reserved resource and a second CPE of the second reserved resource. The set of instructions, when executed by one or more processors of the first UE, may cause the first UE to transmit the indication to one or more of the second UE or the third UE.

Some aspects described herein relate to a non-transitory computer-readable medium that stores a set of instructions for wireless communication by a second UE. The set of instructions, when executed by one or more processors of the second UE, may cause the second UE to transmit, to a first UE, SCI indicating a reserved resource that is associated with a CPE. The set of instructions, when executed by one or more processors of the second UE, may cause the second UE to receive an indication of inconsistent CPEs. The set of instructions, when executed by one or more processors of the second UE, may cause the second UE to adjust a length of the CPE or use a preferred resource based at least in part on the indication.

Some aspects described herein relate to a first apparatus for wireless communication. The first apparatus may include means for receiving first SCI indicating a first reserved resource for a second apparatus. The first apparatus may include means for receiving second SCI indicating a second reserved resource for a third apparatus. The first apparatus may include means for generating an indication of inconsistent CPEs based at least in part on a first CPE of the first reserved resource and a second CPE of the second reserved resource. The first apparatus may include means for transmitting the indication to one or more of the second apparatus or the third apparatus.

Some aspects described herein relate to a second apparatus for wireless communication. The second apparatus may include means for transmitting, to a first apparatus, SCI indicating a reserved resource that is associated with a CPE. The second apparatus may include means for receiving an indication of inconsistent CPEs. The second apparatus may include means for adjusting a length of the CPE or using a preferred resource based at least in part on the indication.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components. non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating examples of cyclic prefix extensions (CPEs), in accordance with the present disclosure.

FIG. 7 is a diagram illustrating an example of inconsistent CPEs, in accordance with the present disclosure.

FIG. 8 is a diagram illustrating another example of inconsistent CPEs, in accordance with the present disclosure.

FIG. 9 is a diagram illustrating an example of indicating inconsistent CPEs, in accordance with the present disclosure.

FIG. 10 is a diagram illustrating examples of scenarios for indicating inconsistent CPEs, in accordance with the present disclosure.

FIG. 11 is a diagram illustrating examples of scenarios for indicating inconsistent CPEs, in accordance with the present disclosure.

FIG. 12 is a diagram illustrating an example process performed, for example, by a first UE, in accordance with the present disclosure.

FIG. 13 is a diagram illustrating an example process performed, for example, by a second UE, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

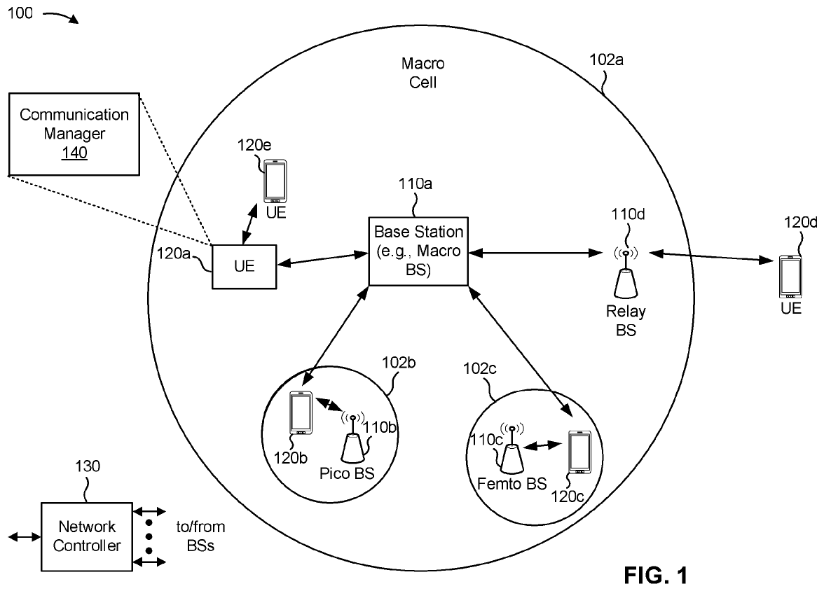

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1I (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24 25 GHz). Frequency bands falling within FR3 may inherit FR1 characteristics and/or FR2 characteristics, and thus may effectively extend features of FR1 and/or FR2 into mid-band frequencies In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120) may include a communication manager 140. As described in more detail elsewhere herein, the communication manager 140 may receive first sidelink control information (SCI) indicating a first reserved resource for a second UE. The communication manager 140 may receive second SCI indicating a second reserved resource for a third UE. The communication manager 140 may generate an indication of inconsistent cyclic prefix extensions (CPEs) based at least in part on a first CPE of the first reserved resource and a second CPE of the second reserved resource. The communication manager 140 may transmit the indication to one or more of the second UE or the third UE.

In some aspects, a second UE (e.g., UE 120) may include a communication manager 140. As described in more detail elsewhere herein, the communication manager 140 may transmit, to a first UE, SCI indicating a reserved resource that is associated with a CPE. The communication manager 140 may receive an indication of inconsistent CPEs. The communication manager 140 may adjust a length of the CPE or use a preferred resource based at least in part on the indication. Additionally, or alternatively, the communication manager 140 may perform one or more other operations described herein.

As indicated above, FIG. 1 is provided as an example. Other examples may differ from what is described with regard to FIG. 1.

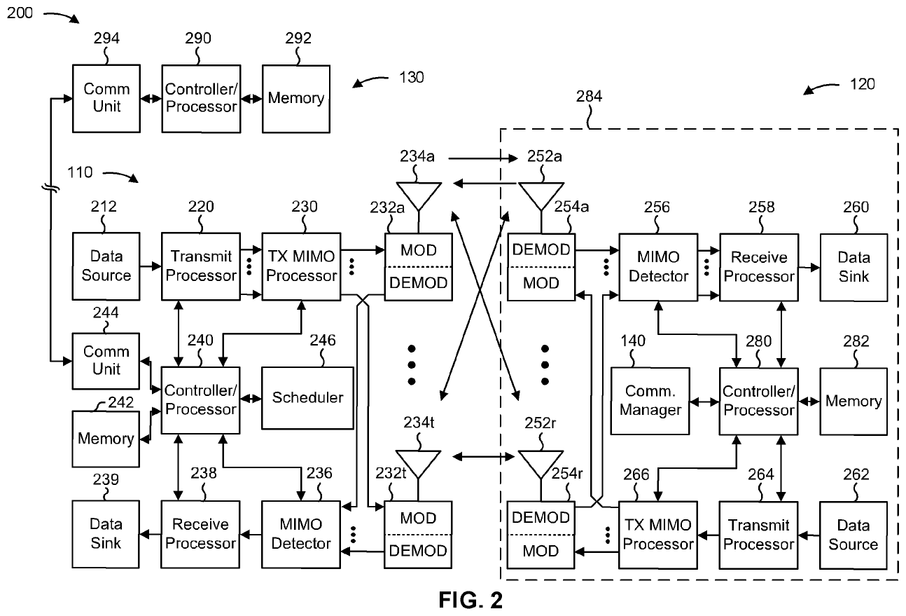

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

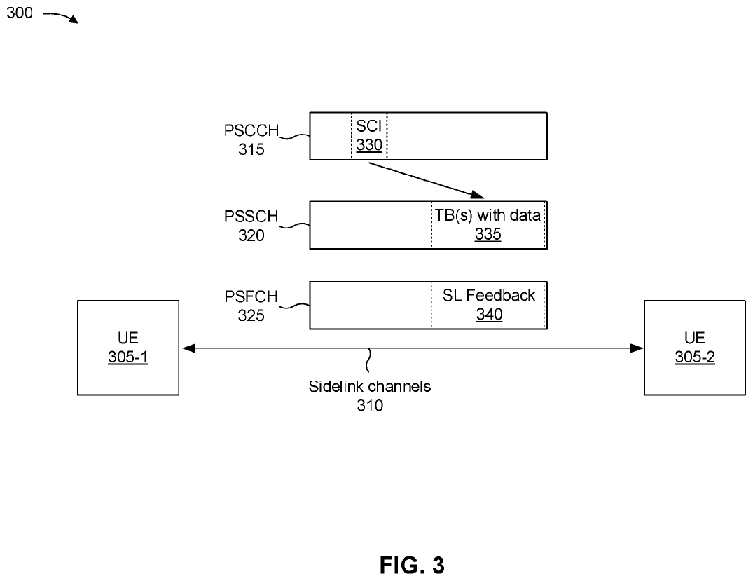

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-14).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-14).

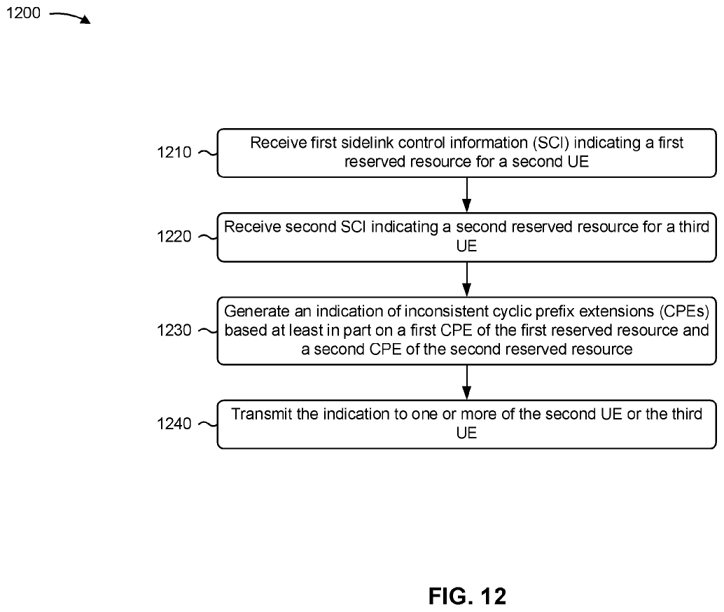

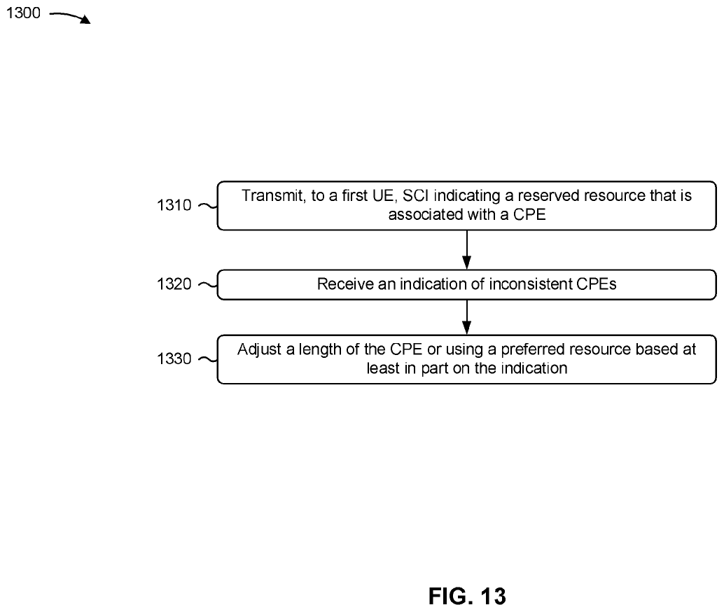

A controller/processor of a network entity (e.g., the controller/processor 240 of the base station 110), the controller/processor 280 of the UE 120, and/or any other component(s) of FIG. 2 may perform one or more techniques associated with indicating inconsistent CPEs, as described in more detail elsewhere herein. In some aspects, the first device described herein is a UE 120, is included in a UE 120, or includes one or more components of a UE 120 shown in FIG. 2. In some aspects, the second device described herein is a UE 120, is included in a UE 120, or includes one or more components of a UE 120 shown in FIG. 2. For example, the controller/processor 280 of the UE 120 and/or any other component(s) of FIG. 2 may perform or direct operations of, for example, process 1200 of FIG. 12, process 1300 of FIG. 13, and/or other processes as described herein. The memory 282 may store data and program codes for the UE 120. In some examples, the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the UE 120, may cause the one or more processors, and/or the UE 120 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a first UE (e.g., UE 120) includes means for receiving first SCI indicating a first reserved resource for a second UE; means for receiving second SCI indicating a second reserved resource for a third UE; means for generating an indication of inconsistent CPEs based at least in part on a first CPE of the first reserved resource and a second CPE of the second reserved resource; and/or means for transmitting the indication to one or more of the second UE or the third UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the second UE (e.g., UE 120) includes means for transmitting, to a first UE, SCI indicating a reserved resource that is associated with a CPE; means for receiving an indication of inconsistent CPEs; and/or means for adjusting a length of the CPE or using a preferred resource based at least in part on the indication. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or an MCS. The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

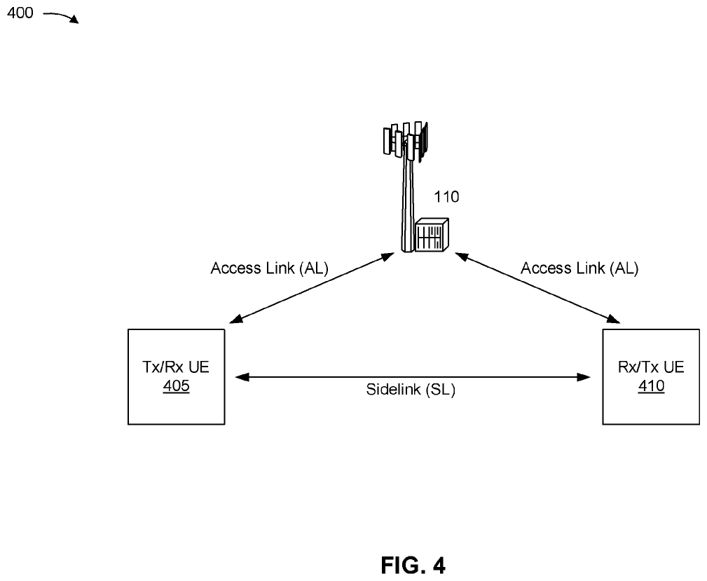

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 4. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

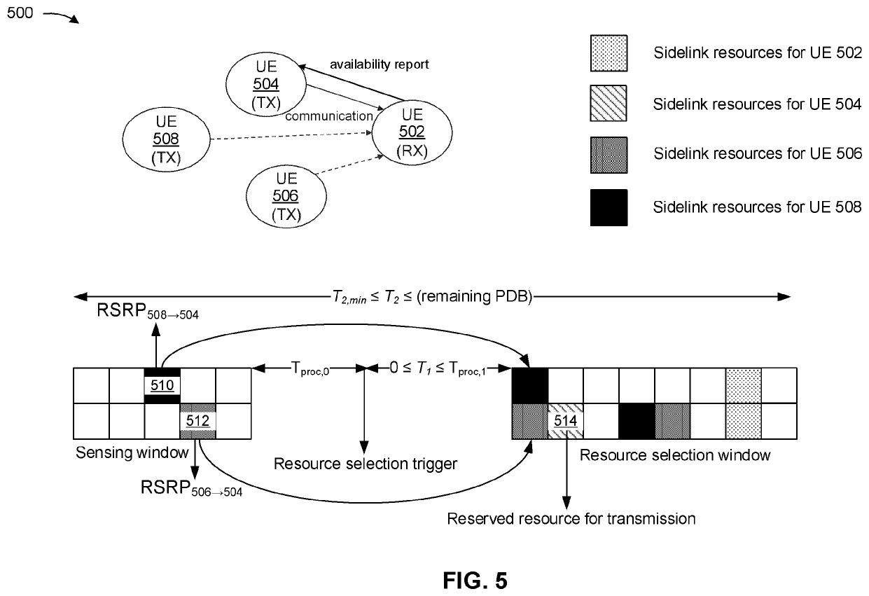

FIG. 5 is a diagram illustrating an example 500 of selecting sidelink resources, in accordance with the present disclosure. Example 500 shows a UE 502 (e.g., a UE 502) that may receive communications on a sidelink channel from other UEs (e.g., a UE 504), such as UE 504, UE 506, and/or UE 508.

As described in connection with FIG. 5, UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502. The report may be request-based (e.g., UE 504 requested) or condition-based (e.g., UE 502 determines whether to send the report).

If UE 504 is to transmit a communication to UE 502, UE 504 may sense the sidelink channel in a sensing window to determine which sidelink resources (e.g., subcarriers, subchannels) are available. A sidelink resource may be considered available if the sidelink resource is clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching a threshold level (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

UE 504 may be power-sensitive and thus may not afford to continually sense all of the sidelink resources. UE 502 may be more capable of sensing and reporting on the sidelink resources because, for example, UE 502 may be a smart phone while UE 504 may be a smart watch. UE 502 may receive unicast communications from UE 504, and UE 502 may report back available resources to UE 504. UE 502 may continually sense the sidelink resources and measure interference levels involving neighboring UEs. For example, LE 502 may measure an RSRP of a signal from neighboring UE 506 as −92 dBm and an RSRP of a signal from neighboring UE 508 as −102 dBm. For a signal of a last transmission of UE 504, UE 502 may have measured a target signal level with an RSRP that was −90 dBm. UE 502 may estimate a signal-to-interference ratio (SIR) of a signal between UE 502 and UE 504 as −90−(−92)=2 dB and an SIR between UE 504 and UE 508 as −90−(−102)=12 dB. If the SIR of a signal from UE 504 to UE 502 with interference from UE 508 is large enough (satisfies an availability threshold) for reliable communication between UE 502 and UE 504, UE 502 may mark a sidelink resource that was reserved by UE 508 as available for use for a communication from UE 504 to UE 502. This may be useful when UE 504 has more than one data stream with varying QoS requirements or transmissions with different MCS indices.

UE 502 may transmit a report indicating an availability of each sidelink resource. Rows in the report may represent subcarriers or subchannels, and columns may represent time units (e.g., slots, symbols). The report may be a binary report, such as a bitmap. For example, UE 502 may report a 1 bit for available and a 0 bit for unavailable. UE 504 may decode the report and select (e.g., randomly) N resources from the available sidelink resources for potential N transmissions of a newly generated packet, or a packet of a transport block that has not been transmitted before. UE 504 may select N=4 sidelink resources from the available sidelink resources indicated by the report. UE 504 may also use the report to perform retransmission or resource reselection.

In some aspects, the report may involve different inter-UE coordination schemes that report different information. For example, the report may include information of Type A, which indicates one or more preferred sidelink resources for transmission. The report may include information of Type B, which indicates one or more non-preferred sidelink resources for transmission. The report may include information of Type C, which indicates expected, potential, or detected collisions of one or more sidelink resources. Information of Type A and Type B may be for a first inter-UE coordination scheme, and information of Type C may be for a second inter-UE coordination scheme. The report may involve down-selection in what resources are reported.

In some scenarios, UE 502 may be capable of IC in sidelink receiving. IC involves canceling interference to obtain a better signal. IC may be symbol level IC (SLIC). UE 502 may perform channel estimation and demodulation on a received signal, obtain a hard decision, and reconstruct a received interfering signal. UE 502 may perform IC and detect a desired signal. IC may be codeword level IC (CWIC), where decoding is further performed. CWIC may be more robust than SLIC.

UE 502 may decode a first transmission, perform IC, and decode another transmission in the same resource. As a result, UE 502, as an IC-capable UE, may be able to decode overlapping transmissions (two transmissions that are sent in overlapping resources). Overlapping transmissions can be common in sidelink autonomous resource allocation. In a broadcast/groupcast dominated network (e.g., V2X), if UE 502 uses IC, there may less interference in the overlapping transmissions. That is, received transmissions may be a desired signal from a receiver UE point of view. V2X reliability and network capacity can be improved with IC operations.

IC has not been considered for resource preference indication. A resource may be determined to be “preferred” if the resource has not been reserved by other UEs or if the resource has been reserved but the RSRP measured from the reservation signal (e.g., SCI) is below an RSRP threshold. A resource may be determined to be “non-preferred” if the resource has been reserved by other UEs and the RSRP measured from the reservation signal (e.g., SCI) is above the RSRP threshold. Furthermore, sidelink receiver capabilities (such as an IC capability) have not been considered in resource preference determination.

As indicated above, FIG. 5 is provided as an example. Other examples may differ from what is described with regard to FIG. 5.

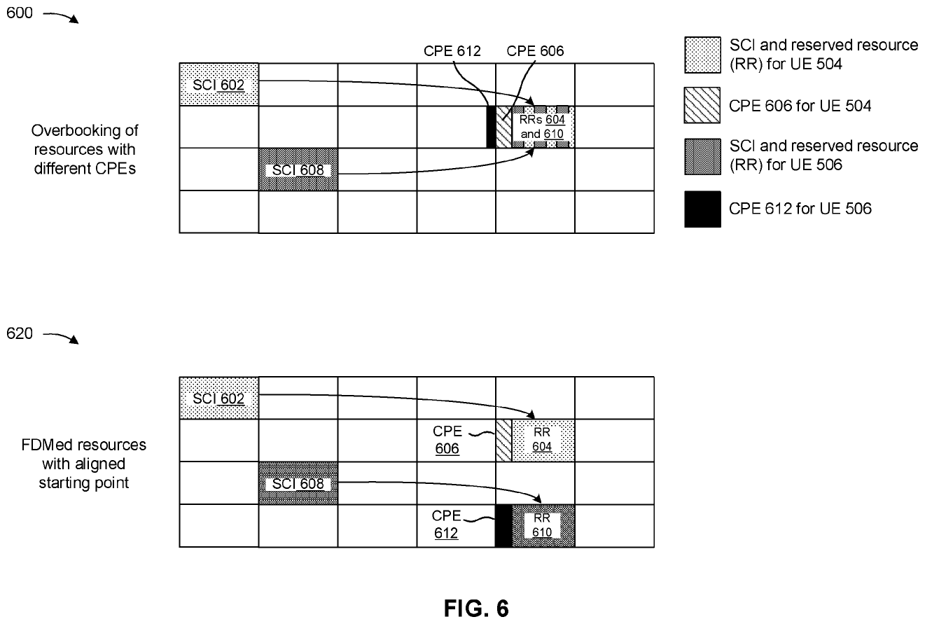

FIG. 6 is a diagram illustrating examples 600 and 620 of CPEs, in accordance with the present disclosure.

In unlicensed spectrum, due to listen-before-talk (LBT) uncertainty when assessing whether a sidelink resource is clear, sidelink Mode 2 resource allocation can be inefficient. Even if a resource is reserved, there is no guarantee that the resource is actually used, which means that other UEs that monitored the reservation may have unnecessarily excluded such resources during their selection. Unused resources and overexclusion of resources reduces the overall system capacity. To minimize the chance of wasting a given resource, multiple UEs may overbook the same resource.

Interference is also an issue in sidelink communications. Sidelink transmissions may use a cyclic prefix (CP) at the start of a transmission to mitigate interference between symbols of sidelink resources. The CP may be a copy of some of the sidelink transmission. Some enhancements to sidelink communications may include the use of a CP extension (CPE). The CPE may be a specified length (e.g., quantity of symbols, symbol length, time in microseconds (μs)) and provide more flexibility in mitigating interference. The length of the CPE may vary based on a subcarrier spacing. If two CPEs are of different lengths, the starting position is different because the CPEs are with respect to a same reference point. Different CPEs (different lengths and starting positions) may be used for different UEs to avoid collision. While different CPEs are beneficial to avoid collision for overbooked resources, the use of different CPEs may cause inter-UE blocking (resource exclusion) if the reserved resources from different UEs are frequency division multiplexed (FDMed) (non-overlapping in the frequency domain). For non-overlapping frequency allocation, UEs may block each other's LBT if transmission starting positions are not aligned.

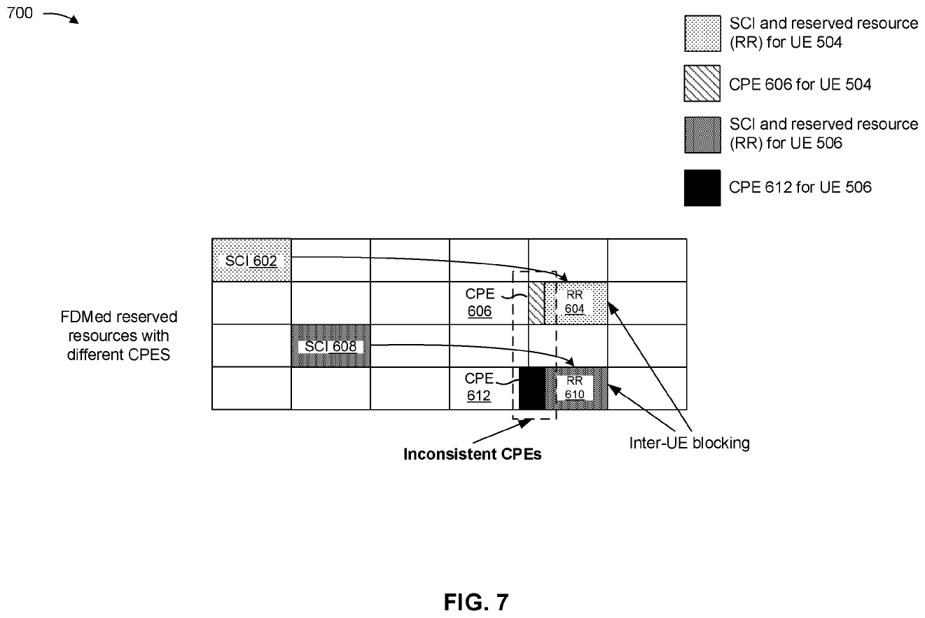

Example 600 shows a first SCI 602 that indicates a first reserved resource (RR) 604 for UE 504 and a first CPE 606 of RR 604. Example 600 also shows a second SCI 608 that indicates a second RR 610 with a second CPE 612. UE 502 may receive SCI 602 and SCI 608. RR 604 and RR 610 may be the same reserved resource (overbooked resource) and CPE 606 and CPE 612 may be different (different lengths, different starting positions). Example 620 shows RR 604 and RR 610 FDMed in different frequency resources, and CPE 606 and CPE 612 are the same. However, there may also be reasons (e.g., hidden nodes, half-duplex constraint, processing timeline) that UE 502 is not able to detect SCI from another UE. In this case, it is possible that two UEs may reserve FDMed resources but with different CPEs or reserve the same resource (i.e., overbooking a given resource) but with a same CPE. If either of these scenarios occur, the CPEs may be considered to be inconsistent CPEs. Examples of inconsistent CPEs are illustrated in FIG. 7.

As indicated above, FIG. 6 provides some examples. Other examples may differ from what is described with regard to FIG. 6.

FIG. 7 is a diagram illustrating an example 700 of inconsistent CPEs, in accordance with the present disclosure.

Example 700 shows that because CPE 606 and CPE 612 are different, RR 604 and RR 610 may cause inter-UE blocking, where one or both of UE 504 and UE 506 are excluded from using the resource. This exclusion may cause the resource to go unused, which is a waste of signaling resources. When the selected CPEs between two UEs may cause inter-UE blocking, the CPEs may be considered to be “inconsistent CPEs.” UE 504 and UE 506 may be unaware of the inconsistent CPEs and the resulting problem.

As indicated above, FIG. 7 provides some examples. Other examples may differ from what is described with regard to FIG. 7.

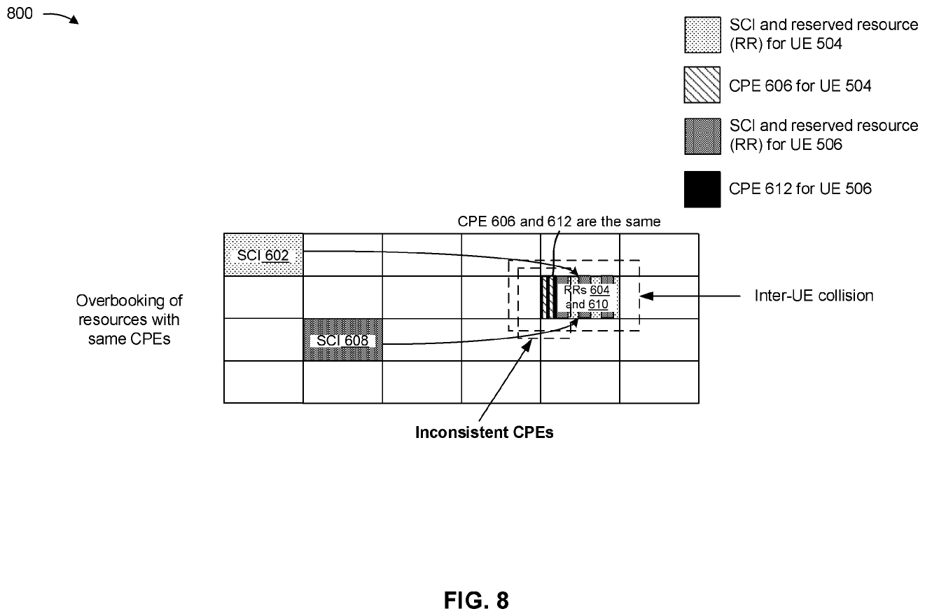

FIG. 8 is a diagram illustrating another example 800 of inconsistent CPEs, in accordance with the present disclosure.

Example 800 shows that inter-UE collision may occur due to the CPEs being the same and thus having the same starting positions for an overbooked resource. When the selected CPEs between two UEs may cause inter-UE collision, or some other problem with the use of reserved resources, the CPEs may be considered to be “inconsistent CPEs.” Again, UE 504 and UE 506 may be unaware of the inconsistent CPEs and the resulting problem.

As indicated above, Fig. is provided as an example. Other examples may differ from what is described with regard to FIG. 8.

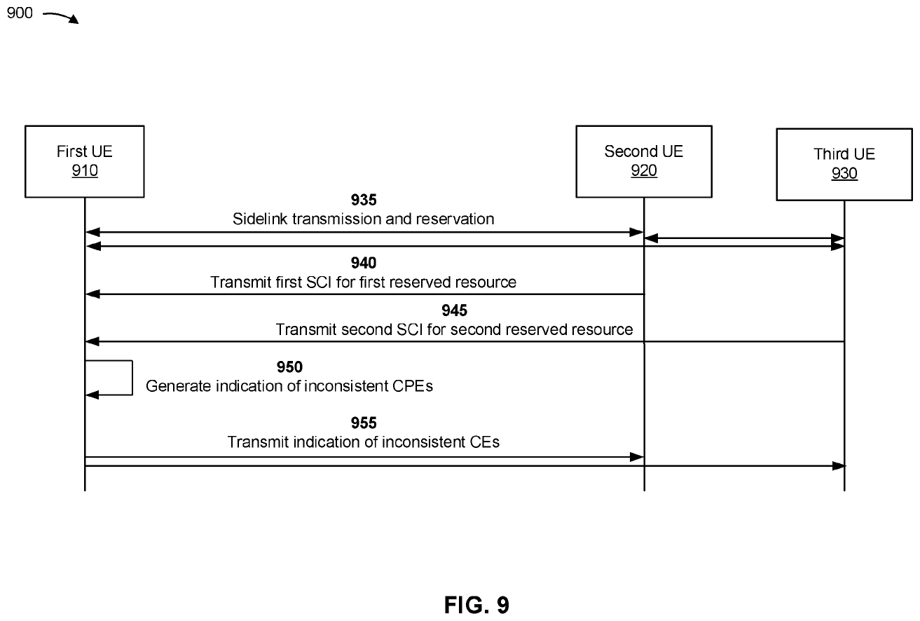

FIG. 9 is a diagram illustrating an example 900 of indicating inconsistent CPEs, in accordance with the present disclosure. As shown in FIG. 9, a first UE 910 (e.g., UE 120, UE 502) may communicate with a second UE 920 (e.g., UE 120, UE 504) a third UE 930 (e.g., UE 120, UE 506), or a fourth UE (e.g., UE 120) using a sidelink. The UEs may be performing sidelink transmission and reservation, as shown by reference number 935.

As shown by reference number 940, UE 920 may transmit first SCI for a first reserved resource. As shown by reference number 945, UE 930 may transmit second SCI for a second reserved resource. UE 910 may determine that the first CPE of the first reserved resource and the second CPE of the second reserved resource are inconsistent CPEs. For example, the CPEs may be for FDMed resources but with different starting positions, or the CPEs may be the same for an overbooked resource. A collision or resource exclusion is likely to take place.

As shown by reference number 950, UE 910 may generate the indication of inconsistent CPEs. The indication may be generated based at least in part on the first CPE and the second CPE (e.g., the CPEs being inconsistent). For example, UE 910 may generate the indication based at least in part on the first reserved resource and the second reserved resource at least partially overlapping in time and not overlapping in frequency (FDMed) and the first CPE being not equal to the second CPE. In some aspects, UE 910 may generate the indication further based at least in part on a distance between the second UE and the third UE satisfying a distance threshold. If the UEs are far enough away from each other, inconsistent CPEs may not be an issue. If the UEs are close enough (e.g., within a minimum distance), inconsistent CPEs may be an issue and the indication may be generated.

Alternatively, in some aspects, UE 910 may generate the indication further based at least in part on UE 920 being in a list of UE 930 and UE 930 being in a list of UE 920. That is, the UEs may be aware of each other (e.g., receive SCI) and a possible impact of other UEs. For example, UE 920 may have a list that includes the UEs from which the RSSI at UE 920 satisfies a first threshold (e.g., first minimum RSSI), and UE 930 may have a list of UEs from which the RSSI at UE 930 satisfies a second threshold (e.g., second minimum RSSI). The first threshold and the second threshold may be the same or different. In some aspects, an additional condition may be that UE 910 has a list that includes the UEs from which the RSSI at UE 920 is above a first threshold, and UE 910 has a list that includes the UEs from which the RSSI at UE 930 is above a second threshold, where the first threshold and the second threshold may be the same or different.

In some aspects, UE 910 may generate the indication based at least in part on the first reserved resource and the second reserved resource at least partially overlapping in time and frequency, and the first CPE being equal to the second CPE. That is, the CPEs may be the same and for an overbooked resource. In some aspects, UE 910 may generate the indication further based at least in part on UE 910 being an intended receiver of UE 920 in the first reserved resource and a first signal strength (e.g., RSRP) of a second transmission from UE 930 satisfying a first signal threshold (e.g., maximum RSRP), or on UE 910 being an intended receiver of UE 930 in the second reserved resource and a second signal strength of a second transmission from UE 920 satisfying the first signal threshold.

Alternatively, in some aspects, UE 910 may generate the indication based at least in part on a difference between a first signal strength of a first transmission from UE 920 projected to the first reserved resource and a second signal strength of a second transmission from UE 930 projected to the second reserved resource satisfying a signal strength difference threshold, and the first reserved resource and the second reserved resource at least partially overlapping in time and frequency. For example, if UE 910 is an intended receiver for a PSSCH communication in the first reserved resource of UE 920, UE 910 may determine that CPEs are inconsistent based at least in part on RSRP2>RSRP1+delta threshold (e.g., Delta_Th), where RSRP1 and RSRP2 are the RSRP measurements from UE 910 for UE 920 and UE 930, respectively. UE 910 may determine that CPEs are inconsistent based at least in part on UE 910 being an intended receiver for a PSSCH communication in the second reserved resource of UE 930 and RSRP1>RSRP2+the delta threshold. The RSRP may be measured based at least in part on the first SCI or the transmission scheduled by the first SCI which may be before the first reserved resource, while the RSRP may not be based on the transmission in the first reserved resource.

As shown by reference number 955, UE 910 may transmit the indication (e.g., via SCI-2 and/or a medium access control control element (MAC CE)) to UE 920 and/or UE 930. In some aspects, UE 910 may transmit the indication to whichever of UE 920 and UE 930 is associated with a shorter CPE. Alternatively, UE 910 may transmit the indication to whichever of UE 920 and UE 930 is associated with a longer CPE. In some aspects, UE 910 may transmit the indication to whichever of UE 920 and UE 930 has a CPE that is different than a default CPE that is specified in stored configuration information or configured by RRC signaling. This can include both UE 920 and UE 930.

In some aspects, UE 910 may transmit the indication to both UE 920 and UE 930 based at least in part on the first CPE and the second CPE not overlapping in frequency and the first CPE being not equal to the second CPE. In some aspects, UE 910 may transmit the indication to whichever of UE 920 and UE 930 has a lower transmission priority. UE 920 and UE 920 may have CPEs that are the same or different.

In some aspects, UE 910 may receive a control message indicating a condition to generate the indication. The condition may be configured via RRC. The condition may be one of the scenarios in which the CPEs are considered to be inconsistent. In some aspects, UE 910 may receive control information associated with a UE capability of UE 920 or UE 930 for using indications of inconsistent CPEs, and UE 910 may generate and transmit the indication based at least in part on the UE capability.

By informing UE 920 and/or UE 930 of inconsistent CPEs, UE 910 may help UE 920 and UE 930 to reschedule a resource or proceed with using a resource to avoid collisions and exclusions and conserve signaling resources.

As indicated above, FIG. 9 is provided as an example. Other examples may differ from what is described with respect to FIG. 9.

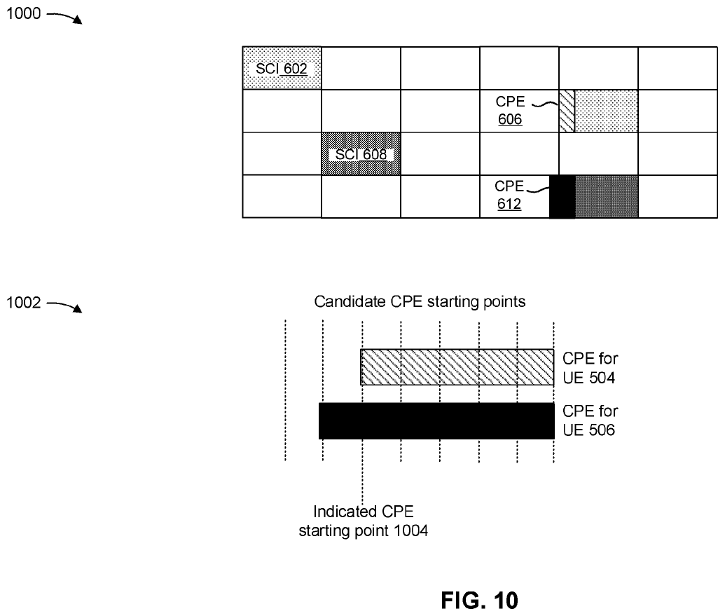

FIG. 10 is a diagram illustrating examples 1000 and 1002 of scenarios for indicating inconsistent CPEs, in accordance with the present disclosure.

The indication of inconsistent CPEs may be carried in the PSFCH. In some aspects, the indication may provide information by which UE 920 and/or UE 930 may perform an adjustment. Alternatively, the information on CPE adjustment may be carried in SCI-2 and/or a MAC CE. Example 1000 shows FDMed resources with different CPEs. In some aspects, the indication may indicate whether to align the CPE with a default CPE The indication may be a single bit, for example, on the PSFCH. In some aspects, the indication may indicate the CPE that UE 920 and/or UE 930 is to use, which may include multiple bits, for example, on the PSFCH, SCI-2, or a MAC CE. A candidate CPE list may be specified or configured, and the indicated CPE may be from the candidate CPE list (e.g., identified by an index in the list). Example 1002 shows that the indication may indicate a CPE index that is mapped to a CPE with starting point 1004. This may include an explicit symbol number or time instance.

As indicated above, FIG. 10 provides some examples. Other examples may differ from what is described with regard to FIG. 10.

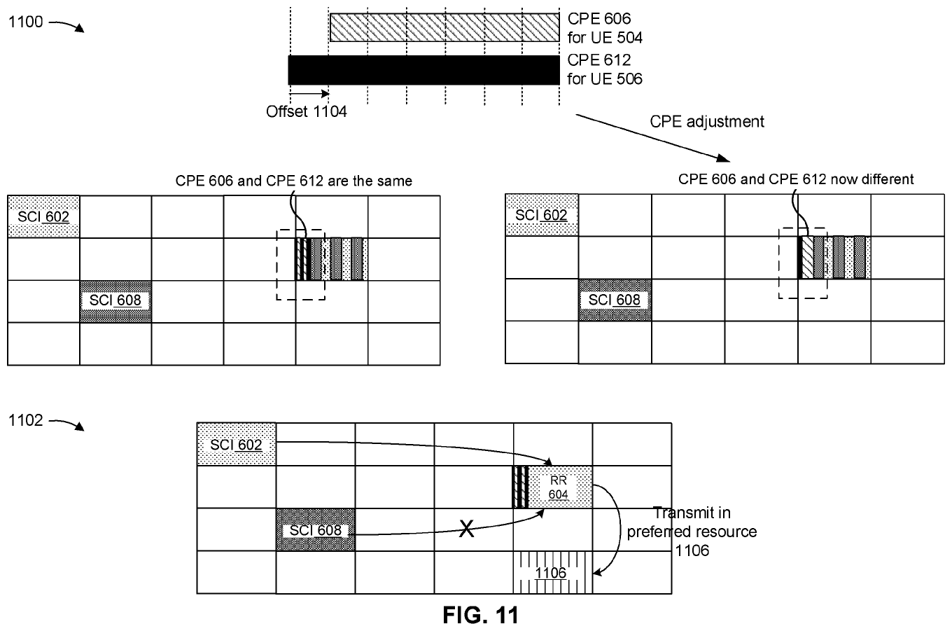

FIG. 11 is a diagram illustrating examples 1100 of scenarios for indicating inconsistent CPEs, in accordance with the present disclosure.

In some aspects, as shown by example 1100, the indication of inconsistent CPEs may indicate a CPE adjustment offset 1104 on top of the current CPE associated with the reserved resource of UE 920 or UE 930. The offset 1104 may add to or subtract from the current CPE to move the starting point earlier or later. Since there is an overbooked resource in example 1100, the indication of inconsistent CPEs may be received when CPE 606 and CPE 612 are the same (before any offset is applied). Then, after receiving the indication, the offset 1104 will adjust CPE 606 and CPE 612 to be different.

In some aspects, as shown by example 1102, the indication may indicate a preferred resource 1106 in which to transmit. The indication may indicate a time and frequency of the preferred resource 1106.

As indicated above, FIG. 11 is provided as an example. Other examples may differ from what is described with regard to FIG. 11.

In some aspects, UE 920 and/or UE 930 may perform one or more adjustments based at least in part on the indication. An adjustment may include adjusting the length of the CPE. UE 920, for example, may align the length of the CPE with a length of a default CPE based at least in part on the indication. UE 920 may adjust the length of the CPE to match a length of a CPE indicated by, for example, an index in the indication. UE 920 may adjust the length of the CPE by applying a CPE adjustment offset indicated in the indication to the length of the CPE. In some aspects, UE 920 may use the preferred resource indicated in the indication. By making an adjustment after receiving the indication of inconsistent CPEs, UE 920 and/or UE 930 may avoid problems associated with inconsistent CPEs.

FIG. 12 is a diagram illustrating an example process 1200 performed, for example, by a first UE, in accordance with the present disclosure. Example process 1200 is an example where the UE (e.g., UE 120, UE 502, UE 910) performs operations associated with indicating inconsistent CPEs.

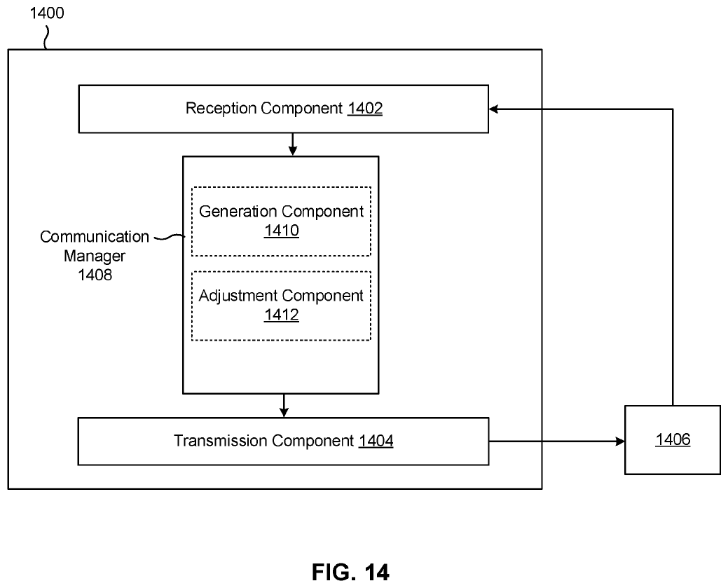

As shown in FIG. 12, in some aspects, process 1200 may include receiving first SCI indicating a first reserved resource for a second UE (block 1210). For example, the UE (e.g., using communication manager 1408 and/or reception component 1402 depicted in FIG. 14) may receive first SCI indicating a first reserved resource for a second UE, as described in connection with FIGS. 6-11.

As further shown in FIG. 12, in some aspects, process 1200 may include receiving second SCI indicating a second reserved resource for a third UE (block 1220). For example, the UE (e.g., using communication manager 1408 and/or reception component 1402 depicted in FIG. 14) may receive second SCI indicating a second reserved resource for a third UE, as described in connection with FIGS. 6-11.

As further shown in FIG. 12, in some aspects, process 1200 may include generating an indication of inconsistent CPEs based at least in part on a first CPE of the first reserved resource and a second CPE of the second reserved resource (block 1230). For example, the UE (e.g., using communication manager 1408 and/or generation component 1410 depicted in FIG. 14) may generate an indication of inconsistent CPEs based at least in part on a first CPE of the first reserved resource and a second CPE of the second reserved resource, as described in connection with FIGS. 6-11.

As further shown in FIG. 12, in some aspects, process 1200 may include transmitting the indication to one or more of the second UE or the third UE (block 1240). For example, the UE (e.g., using communication manager 1408 and/or transmission component 1404 depicted in FIG. 14) may transmit the indication to one or more of the second UE or the third UE, as described in connection with FIGS. 6-11.

Process 1200 may include additional aspects, such as any single aspect or any combination of aspects described below and/or in connection with one or more other processes described elsewhere herein.

In a first aspect, generating the indication includes generating the indication based at least in part on the first reserved resource and the second reserved resource at least partially overlapping in time and not overlapping in frequency, and the first CPE being not equal to the second CPE.

In a second aspect, alone or in combination with the first aspect, generating the indication includes generating the indication further based at least in part on a distance between the second UE and the third UE satisfying a distance threshold.

In a third aspect, alone or in combination with one or more of the first and second aspects, generating the indication includes generating the indication further based at least in part on the second UE being in a list of the third UE and the third UE being in a list of the second UE.

In a fourth aspect, alone or in combination with one or more of the first through third aspects, generating the indication includes generating the indication based at least in part on the first reserved resource and the second reserved resource at least partially overlapping in time and frequency, and the first CPE being equal to the second CPE.

In a fifth aspect, alone or in combination with one or more of the first through fourth aspects, generating the indication includes generating the indication further based at least in part on one of the first UE being an intended receiver of the second UE in the first reserved resource and a first signal strength of a second transmission from the third UE satisfying a first signal threshold, or the first UE being an intended receiver of the third UE in the second reserved resource and a second signal strength of a second transmission from the second UE satisfying the first signal threshold.

In a sixth aspect, alone or in combination with one or more of the first through fifth aspects, generating the indication includes generating the indication further based at least in part on a difference between a first signal strength of a first transmission from the second UE projected to the first reserved resource and a second signal strength of a second transmission from the third UE projected to the second reserved resource satisfying a signal strength difference threshold, and the first reserved resource and the second reserved resource at least partially overlapping in time and frequency.

In a seventh aspect, alone or in combination with one or more of the first through sixth aspects, process 1200 includes receiving a control message indicating a condition to generate the indication.

In an eighth aspect, alone or in combination with one or more of the first through seventh aspects, transmitting the indication to one or more of the second UE or the third UE includes transmitting the indication to whichever of the second UE and the third UE is associated with a shorter CPE.

In a ninth aspect, alone or in combination with one or more of the first through eighth aspects, transmitting the indication to one or more of the second UE or the third UE includes transmitting the indication to whichever of the second UE and the third UE is associated with a longer CPE.

In a tenth aspect, alone or in combination with one or more of the first through ninth aspects, transmitting the indication to one or more of the second UE or the third UE includes transmitting the indication to which ones of the second UE and the third UE have a CPE that is different than a default CPE that is specified in stored configuration information or configured by radio resource control signaling.

In an eleventh aspect, alone or in combination with one or more of the first through tenth aspects, transmitting the indication to one or more of the second UE or the third UE includes transmitting the indication to both the second UE and the third UE based at least in part on the first CPE and the second CPE not overlapping in frequency and the first CPE being not equal to the second CPE.

In a twelfth aspect, alone or in combination with one or more of the first through eleventh aspects, transmitting the indication to one or more of the second UE or the third UE includes transmitting the indication to whichever of the second UE and the third UE has a lower transmission priority.

In a thirteenth aspect, alone or in combination with one or more of the first through twelfth aspects, process 1200 includes receiving control information associated with a UE capability of the second UE or the third UE for using indications of inconsistent CPEs, and generating the indication includes generating the indication based at least in part on the UE capability.

In a fourteenth aspect, alone or in combination with one or more of the first through thirteenth aspects, the indication includes an instruction to align a CPE of a reserved resource with a default CPE.

In a fifteenth aspect, alone or in combination with one or more of the first through fourteenth aspects, the indication includes an index of a CPE that is to be applied to a reserved resource.

In a sixteenth aspect, alone or in combination with one or more of the first through fifteenth aspects, the indication includes a CPE adjustment offset that is to be applied to a current CPE of a reserved resource.

In a seventeenth aspect, alone or in combination with one or more of the first through sixteenth aspects, the indication indicates a preferred resource.

In an eighteenth aspect, alone or in combination with one or more of the first through seventeenth aspects, transmitting the indication includes transmitting the indication in a PSFCH.

In a nineteenth aspect, alone or in combination with one or more of the first through eighteenth aspects, transmitting the indication includes transmitting the indication in SCI 2 or a MAC CE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a second UE, in accordance with the present disclosure. Example process 1300 is an example where the UE (e.g., UE 120, UE 504, UE 920) performs operations associated with making adjustments based at least in part on receiving an indication of inconsistent CPEs.

As shown in FIG. 13, in some aspects, process 1300 may include transmitting, to a first UE, SCI indicating a reserved resource that is associated with a CPE (block 1310). For example, the UE (e.g., using communication manager 1408 and/or transmission component 1404 depicted in FIG. 14) may transmit, to a first UE, SCI indicating a reserved resource that is associated with a CPE, as described in connection with FIGS. 6-11.

As further shown in FIG. 13, in some aspects, process 1300 may include receiving an indication of inconsistent CPEs (block 1320). For example, the UE (e.g., using communication manager 1408 and/or reception component 1402 depicted in FIG. 14) may receive an indication of inconsistent CPEs, as described in connection with FIGS. 6-11.

As further shown in FIG. 13, in some aspects, process 1300 may include adjusting a length of the CPE or using a preferred resource based at least in part on the indication (block 1330). For example, the UE (e.g., using communication manager 1408 and/or adjustment component 1412 depicted in FIG. 14) may adjust a length of the CPE or use a preferred resource based at least in part on the indication, as described in connection with FIGS. 6-11.

Process 1300 may include additional aspects, such as any single aspect or any combination of aspects described below and/or in connection with one or more other processes described elsewhere herein.

In a first aspect, adjusting the length of the CPE includes aligning the length of the CPE with a length of a default CPE based at least in part on the indication.

In a second aspect, alone or in combination with the first aspect, adjusting the length of the CPE includes adjusting the length of the CPE to match a length of a CPE indicated by an index in the indication.

In a third aspect, alone or in combination with one or more of the first and second aspects, adjusting the length of the CPE includes adjusting the length of the CPE by applying a CPE adjustment offset indicated in the indication to the length of the CPE.

In a fourth aspect, alone or in combination with one or more of the first through third aspects, using the preferred resource includes using the preferred resource indicated in the indication.

In a fifth aspect, alone or in combination with one or more of the first through fourth aspects, process 1300 includes transmitting control information associated with a UE capability for using indications of inconsistent CPEs.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE (e.g., UE 120), or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408. The communication manager 1408 may control and/or otherwise manage one or more operations of the reception component 1402 and/or the transmission component 1404. In some aspects, the communication manager 1408 may include one or more antennas, a modem, a controller/processor, a memory, or a combination thereof, of the UE described in connection with FIG. 2. The communication manager 1408 may be, or be similar to, the communication manager 140 depicted in FIGS. 1 and 2. For example, in some aspects, the communication manager 1408 may be configured to perform one or more of the functions described as being performed by the communication manager 140. In some aspects, the communication manager 1408 may include the reception component 1402 and/or the transmission component 1404. The communication manager 1408 may include a generation component 1410 and/or an adjustment component 1412, among other examples.

In some aspects, the apparatus 1400 may be configured to perform one or more operations described herein in connection with FIGS. 1-11. Additionally, or alternatively, the apparatus 1400 may be configured to perform one or more processes described herein, such as process 1200 of FIG. 12, process 1300 of FIG. 13, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

In some aspects as a first UE (e.g., UE 502, UE 910), the reception component 1402 may receive first SCI indicating a first reserved resource for a second UE. The reception component 1402 may receive second SCI indicating a second reserved resource for a third UE. The generation component 1410 may generate an indication of inconsistent CPEs based at least in part on a first CPE of the first reserved resource and a second CPE of the second reserved resource. The transmission component 1404 may transmit the indication to one or more of the second UE or the third UE.

The reception component 1402 may receive a control message indicating a condition to generate the indication. The reception component 1402 may receive control information associated with a UE capability of the second UE or the third UE for using indications of inconsistent CPEs, and the generation component 1410 may generate the indication based at least in part on the UE capability.

In some aspects as the second UE (e.g., UE 504, UE 920), the transmission component 1404 may transmit, to a first UE, SCI indicating a reserved resource that is associated with a CPE. The reception component 1402 may receive an indication of inconsistent CPEs. The adjustment component 1412 may adjust a length of the CPE or use a preferred resource based at least in part on the indication. The transmission component 1404 may transmit control information associated with a UE capability for using indications of inconsistent CPEs.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a first user equipment (UE), comprising: receiving first sidelink control information (SCI) indicating a first reserved resource for a second UE; receiving second SCI indicating a second reserved resource for a third UE; generating an indication of inconsistent cyclic prefix extensions (CPEs) based at least in part on a first CPE of the first reserved resource and a second CPE of the second reserved resource; and transmitting the indication to one or more of the second UE or the third UE.
Aspect 2: The method of Aspect 1, wherein generating the indication includes generating the indication based at least in part on: the first reserved resource and the second reserved resource at least partially overlapping in time and not overlapping in frequency, and the first CPE being not equal to the second CPE.
Aspect 3: The method of Aspect 2, wherein generating the indication includes generating the indication further based at least in part on a distance between the second UE and the third UE satisfying a distance threshold.
Aspect 4: The method of Aspect 2 or 3, wherein generating the indication includes generating the indication further based at least in part on the second UE being in a list of the third UE and the third UE being in a list of the second UE.
Aspect 5: The method of any of Aspects 1-4, wherein generating the indication includes generating the indication based at least in part on: the first reserved resource and the second reserved resource at least partially overlapping in time and frequency, and the first CPE being equal to the second CPE.
Aspect 6: The method of Aspect 5, wherein generating the indication includes generating the indication further based at least in part on one of: the first UE being an intended receiver of the second UE in the first reserved resource and a first signal strength of a second transmission from the third UE satisfying a first signal threshold, or the first UE being an intended receiver of the third UE in the second reserved resource and a second signal strength of a second transmission from the second UE satisfying the first signal threshold.
Aspect 7: The method of Aspect 5 or 6, wherein generating the indication includes generating the indication further based at least in part on: a difference between a first signal strength of a first transmission from the second UE projected to the first reserved resource and a second signal strength of a second transmission from the third UE projected to the second reserved resource satisfying a signal strength difference threshold, and the first reserved resource and the second reserved resource at least partially overlapping in time and frequency.
Aspect 8: The method of any of Aspects 1-7, further comprising receiving a control message indicating a condition to generate the indication.
Aspect 9: The method of any of Aspects 1-8, wherein transmitting the indication to one or more of the second UE or the third UE includes transmitting the indication to whichever of the second UE and the third UE is associated with a shorter CPE.
Aspect 10: The method of any of Aspects 1-9, wherein transmitting the indication to one or more of the second UE or the third UE includes transmitting the indication to whichever of the second UE and the third UE is associated with a longer CPE.
Aspect 11: The method of any of Aspects 1-10, wherein transmitting the indication to one or more of the second UE or the third UE includes transmitting the indication to which ones of the second UE and the third UE have a CPE that is different than a default CPE that is specified in stored configuration information or configured by radio resource control signaling.
Aspect 12: The method of any of Aspects 1-11, wherein transmitting the indication to one or more of the second UE or the third UE includes transmitting the indication to both the second UE and the third UE based at least in part on the first CPE and the second CPE not overlapping in frequency and the first CPE being not equal to the second CPE.
Aspect 13: The method of any of Aspects 1-12, wherein transmitting the indication to one or more of the second UE or the third UE includes transmitting the indication to whichever of the second UE and the third UE has a lower transmission priority.
Aspect 14: The method of any of Aspects 1-13, further comprising receiving control information associated with a UE capability of the second UE or the third UE for using indications of inconsistent CPEs, and wherein generating the indication includes generating the indication based at least in part on the UE capability.
Aspect 15: The method of any of Aspects 1-14, wherein the indication includes an instruction to align a CPE of a reserved resource with a default CPE.
Aspect 16: The method of any of Aspects 1-15, wherein the indication includes an index of a CPE that is to be applied to a reserved resource.
Aspect 17: The method of any of Aspects 1-16, wherein the indication includes a CPE adjustment offset that is to be applied to a current CPE of a reserved resource.
Aspect 18: The method of any of Aspects 1-17, wherein the indication indicates a preferred resource.
Aspect 19: The method of any of Aspects 1-18, wherein transmitting the indication includes transmitting the indication in a physical sidelink feedback channel communication.
Aspect 20: The method of any of Aspects 1-19, wherein transmitting the indication includes transmitting the indication in SCI 2 or a medium access control control element (MAC CE).
Aspect 21: A method of wireless communication performed by a second user equipment (UE), comprising: transmitting, to a first UE, sidelink control information (SCI) indicating a reserved resource that is associated with a cyclic prefix extension (CPE); receiving an indication of inconsistent CPEs; and adjusting a length of the CPE or using a preferred resource based at least in part on the indication.
Aspect 22: The method of Aspect 21, wherein adjusting the length of the CPE includes aligning the length of the CPE with a length of a default CPE based at least in part on the indication.
Aspect 23: The method of Aspect 21 or 22, wherein adjusting the length of the CPE includes adjusting the length of the CPE to match a length of a CPE indicated by an index in the indication.
Aspect 24: The method of any of Aspects 21-23, wherein adjusting the length of the CPE includes adjusting the length of the CPE by applying a CPE adjustment offset indicated in the indication to the length of the CPE.
Aspect 25: The method of any of Aspects 21-24, wherein using the preferred resource includes using the preferred resource indicated in the indication.
Aspect 26: The method of any of Aspects 21-25, further comprising transmitting control information associated with a UE capability for using indications of inconsistent CPEs.
Aspect 27: An apparatus for wireless communication at a device, comprising a processor; memory coupled with the processor; and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions. instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus of a first user equipment (UE) for wireless communication, comprising:
a memory; and
one or more processors, coupled to the memory, configured to:
receive first sidelink control information (SCI) indicating a first reserved resource for a second UE;
receive second SCI indicating a second reserved resource for a third UE;
generate an indication of inconsistent cyclic prefix extensions (CPEs) based at least in part on a first CPE of the first reserved resource and a second CPE of the second reserved resource; and
transmit the indication to one or more of the second UE or the third UE.

2. The apparatus of claim 1, wherein the one or more processors, to generate the indication, are configured to generate the indication based at least in part on:
the first reserved resource and the second reserved resource at least partially overlapping in time and not overlapping in frequency, and
the first CPE being not equal to the second CPE.

3. The apparatus of claim 2, wherein the one or more processors, to generate the indication, are configured to generate the indication further based at least in part on a distance between the second UE and the third UE satisfying a distance threshold.

4. The apparatus of claim 2, wherein the one or more processors, to generate the indication, are configured to generate the indication further based at least in part on the second UE being in a list of the third UE and the third UE being in a list of the second UE.

5. The apparatus of claim 1, wherein the one or more processors, to generate the indication, are configured to generate the indication based at least in part on:
the first reserved resource and the second reserved resource at least partially overlapping in time and frequency, and
the first CPE being equal to the second CPE.

6. The apparatus of claim 5, wherein the one or more processors, to generate the indication, are configured to generate the indication further based at least in part on one of:
the first UE being an intended receiver of the second UE in the first reserved resource and a first signal strength of a second transmission from the third UE satisfying a first signal threshold, or
the first UE being an intended receiver of the third UE in the second reserved resource and a second signal strength of a second transmission from the second UE satisfying the first signal threshold.

7. The apparatus of claim 5, wherein the one or more processors, to generate the indication, are configured to generate the indication further based at least in part on:
a difference between a first signal strength of a first transmission from the second UE projected to the first reserved resource and a second signal strength of a second transmission from the third UE projected to the second reserved resource satisfying a signal strength difference threshold, and
the first reserved resource and the second reserved resource at least partially overlapping in time and frequency.

8. (canceled)

9. The apparatus of claim 1, wherein the one or more processors, to transmit the indication to one or more of the second UE or the third UE, are configured to transmit the indication to whichever of the second UE and the third UE is associated with a shorter CPE.

10. The apparatus of claim 1, wherein the one or more processors, to transmit the indication to one or more of the second UE or the third UE, are configured to transmit the indication to whichever of the second UE and the third UE is associated with a longer CPE.

11. The apparatus of claim 1, wherein the one or more processors, to transmit the indication to one or more of the second UE or the third UE, are configured to transmit the indication to which ones of the second UE and the third UE have a CPE that is different than a default CPE that is specified in stored configuration information or configured by radio resource control signaling.

12. (canceled)

13. The apparatus of claim 1, wherein the one or more processors, to transmit the indication to one or more of the second UE or the third UE, are configured to transmit the indication to whichever of the second UE and the third UE has a lower transmission priority.

14.-15. (canceled)

16. The apparatus of claim 1, wherein the indication includes an index of a CPE that is to be applied to a reserved resource.

17. The apparatus of claim 1, wherein the indication includes a CPE adjustment offset that is to be applied to a current CPE of a reserved resource.

18.-20. (canceled)

21. An apparatus of a second user equipment (UE) for wireless communication, comprising:
a memory; and
one or more processors, coupled to the memory, configured to:
transmit, to a first UE, sidelink control information (SCI) indicating a reserved resource that is associated with a cyclic prefix extension (CPE);
receive an indication of inconsistent CPEs; and
adjust a length of the CPE or use a preferred resource based at least in part on the indication.

22. The apparatus of claim 21, wherein the one or more processors, to adjust the length of the CPE, are configured to align the length of the CPE with a length of a default CPE based at least in part on the indication.

23. The apparatus of claim 21, wherein the one or more processors, to adjust the length of the CPE, are configured to adjust the length of the CPE to match a length of a CPE indicated by an index in the indication.

24. The apparatus of claim 21, wherein the one or more processors, to adjust the length of the CPE, are configured to adjust the length of the CPE by applying a CPE adjustment offset indicated in the indication to the length of the CPE.

25. The apparatus of claim 21, wherein the one or more processors, to use the preferred resource, are configured to use the preferred resource indicated in the indication.

26. The apparatus of claim 21, wherein the one or more processors are configured to transmit control information associated with a UE capability for using indications of inconsistent CPEs.

27. A method of wireless communication performed by a first user equipment (UE), comprising:
receiving first sidelink control information (SCI) indicating a first reserved resource for a second UE;
receiving second SCI indicating a second reserved resource for a third UE;
generating an indication of inconsistent cyclic prefix extensions (CPEs) based at least in part on a first CPE of the first reserved resource and a second CPE of the second reserved resource; and
transmitting the indication to one or more of the second UE or the third UE.

28-30. (canceled)
